(19) United States
(12) Patent Application Publication
(10) Pub. No.: US 2005/0213923 A1
(43) Pub. Date: Sep. 29, 2005

(54) Method and apparatus for applying materials to an optical substrate

(76) Inventors: Alexander F. Incera, Pomfret Center, CT (US); Wolfgang M. Strobel, Tolland, CT (US); Thomas A. Gordon, Glastonbury, CT (US); David J. Logan, Great Barrington, MA (US)

Correspondence Address: MORGAN & FINNEGAN, L.L.P., 3 WORLD FINANCIAL CENTER, NEW YORK, NY, 10281-2101, US

(21) Appl. No.: 11/040,572

(22) Filed: Jan. 21, 2005

Related U.S. Application Data
(60) Provisional application No. 60/538,312, filed on Jan. 22, 2004.

(51) Int. Cl. G02B 6/00

(52) U.S. Cl. 385/147

(57) ABSTRACT

The apparatus and method described utilizes a discrete deposition process to apply materials to an optical substrate. The materials can be applied to an optical substrate to create an ophthalmic lens or apply a coating to a lens or other optical surface. Average surface roughness below 10 nanometers can be achieved using the described apparatus and method. Localized error is minimized to less than 1 micron over a 1 mm linear distance to avoid a lens anomaly such as a localized power distortion or power wave. Coating is applied to an entire substrate surface or selected portions. Material can be deposited on the optical substrate to provide the substrate with desired refracting properties. One or more surfaces of the substrate can be coated. Waste material is minimized and a uniform coating is applied for the improvement of optical qualities of the substrate.

### RELATED APPLICATIONS

This application claims the benefit of U.S. Provisional Application No. 60/538,312, filed Jan. 22, 2004.

### FIELD OF THE INVENTION

This invention relates to the application of materials to an optical substrate, and to methods and apparatus for the application of materials used in creating a lens and coatings for optical substrates in particular.

### BACKGROUND OF THE INVENTION

Lenses, particularly those used in the manufacture of eyeglasses, are generally fabricated from a polymeric material, such as polycarbonate. While these materials are lightweight, making the eyeglasses more comfortable to wear, they are susceptible to scratching. To address this problem, a material is typically applied to the lens surfaces. Sometimes, this material is applied manually, subjecting the application process to human error potentially resulting in the material being unevenly applied to the lens surface, causing distorted vision and wave interference effects for the person wearing the eyeglasses incorporating these lenses. In addition to distorted vision, improperly applied materials can also result in localized errors (departure from the desired curve), reduced scratch resistance, and unacceptable average surface roughness on the lens surface.

It is also a common practice in the art to coat at least one face of an optical substrate with one or more coatings for imparting to the finished product additional or improved optical or mechanical properties such as improved durability, easy maintenance, visual comfort, eye protection, and reduced eyestrain.

The surface treatments are traditionally applied by dip coating or a spin coating. In the dipping technique, the substrate is immersed within a bath of the coating material and then cured in an oven. This process is expensive and time consuming as the lens must be cured for several hours. In the spin coating technique, a volume of coating material is deposited on a substrate, and a substantial percentage of the coating material is spun off of the substrate during the process. In some instances, the spun-off coating material is no longer practically usable. In other instances, the spun-off coating material may be reclaimed, but the reclamation process requires additional apparatus and cost. Spin coating is often used with optical substrates that have rotational symmetry such as ophthalmic lenses.

Both dip coating and spin coating are typically limited to situations where a coating is applied to an entire surface of a substrate, rather than select portions of the surface. Both techniques also use a significantly higher volume of the coating material to be deposited than is actually deposited.

In addition, the traditional processes for applying materials to an optical substrate typically suffer from certain drawbacks; e.g., uneven material distribution causing distorted vision, reduced scratch resistance, and unacceptable surface roughness; creation of waste materials; higher than desirable cost and time; and inability to practically apply materials to selective portions of the substrate.

What is needed, therefore, is a method and apparatus that reduces the cost of the above-described process by minimizing waste materials, improves optical properties of the lenses, and enables materials to be selectively applied to particular portions of an optical substrate.

### SUMMARY OF THE INVENTION

According to the present invention, a method and apparatus for discrete deposition of materials to an optical substrate is provided. Discrete deposition is a process of selectively disposing a plurality of droplets of material on a surface. The method comprises: providing a material transfer unit having an orifice through which material may be expelled; positioning one of the substrate or the material transfer unit relative to the other in a known positional relationship; expelling a predetermined amount of material from the material transfer unit onto the substrate; and performing a secondary processing step.

The invention, in one aspect, provides a method and apparatus for the discrete deposition of materials to an optical substrate for modifying. the refracting properties of a lens. One advantage of the present invention is that the material can be deposited on the substrate in a manner that gives the optical substrate desired refracting properties.

The invention, in another aspect, provides a method and apparatus for the discrete deposition of surface coatings to one or more surfaces of an optical substrate; e.g., a finished or semi-finished ophthalmic lens.

Another advantage of the present invention is that measured amounts of materials can be applied to particular sites on the optical substrate. As a result, it is possible to apply materials to select portions of the optical substrate, while not applying the material to others.

Another advantage of the present invention is that the present inventive method minimizes the amount of waste material created during the application of the optical substrates, and/or eliminates the need to reprocess waste material.

Another advantage of the present invention is to provide a method and apparatus for applying material to an optical substrate with a more uniform thickness than is provided by most currently available application methodologies. A more uniform thickness, in turn, will provide desirable improvements in certain optical qualities; e.g., reduction in wave interference effects, minimizing any distortion, reduction in average surface roughness, reduction in localized errors, and improved scratch resistance.

### BRIEF DESCRIPTION OF THE DRAWINGS

These and other objects, features and advantages of the present invention will become apparent upon reading the following detailed description and upon reference to the drawings in which:

FIG. 1 is a perspective view of an apparatus utilizing the principles of the present invention;

FIG. 2 is a partial top view of the apparatus in FIG. 1;

FIG. 3 is a partial cross-sectional view of the apparatus in FIG. 1;

FIG. 4 is a flow diagram of a method utilizing the principles illustrated in FIG. 1;

FIG. 5A is a photomicrograph of a spin coating process before material is applied to a substrate; and

FIG. 5B is a photomicrograph of a spin coating process after material is applied to a substrate.

### DETAILED DESCRIPTION OF THE PREFERRED EMBODIMENT

In general, the present invention provides a method and apparatus for the discrete deposition of materials to an optical substrate for the purpose of creating a lens, or for the discrete deposition of surface coatings to one or more surfaces of an optical substrate. Examples of acceptable materials include, but are not limited to, thermosetting plastics such as diethyleneglycol bis-allylcarbonate copolymer or thermoplastic plastics such as polycarbonate. A variety of different coatings can be applied that improve the mechanical and optical characteristics of the substrate. The surface coatings include, but are not limited to, impact resistant coatings, scratch resistant coatings, anti-reflecting coatings, glare resistant coatings, photochromic coatings, dying or marking coatings, and hydrophobic coatings.

The method for applying materials to an optical substrate includes: providing a material transfer unit having an orifice through which material may be expelled; positioning one of the substrate or the material transfer unit relative to the other in a known positional relationship; expelling a predetermined amount of material from the material transfer unit onto the substrate to a predetermined position; and performing a secondary processing step.

In some applications, it may be desirable to add secondary processing steps to the present inventive method. For example, with certain materials, it may be desirable to add an additional secondary processing step to facilitate uniform distribution of the material subsequent to it being deposited on the substrate; e.g., a substrate spinning step, a substrate vibration step, a heat transfer step, and the like. In addition, again depending upon the material, it may be desirable to cure the applied material to desirably change its physical properties. Examples of suitable secondary processing methods that facilitate uniform distribution of the material subsequent to it being deposited on the substrate are disclosed in U.S. Pat. No. 6,129,042 to Smith et al.; U.S. Pat. No. 6,296,707 to Adamczyk et al.; and U.S. Pat. No. 6,326,054 to Smith et al., which are all incorporated herein by reference in their entireties.

Secondary processing steps can also comprise material removal steps including grinding, polishing, fining, abrading, lapping, burnishing, machining, and the like. It is intended that the term material removal be given its broadest interpretation and includes, by way of example, operations wherein material is moved on rather than actually removed from the substrate. It will be appreciated that in some applications, material may be discretely deposited on the optical substrate and then some of the material removed in a secondary material removal step and the operation repeated iteratively until the desired product is achieved. Further secondary processing steps may include changing physical parameters, e.g., by a heating step, a cooling step, an annealing step, and the like.

In one aspect of the invention, the secondary processing step occurs after the expulsion of material from the material transfer unit. Alternatively, the secondary processing step can occur during the expulsion of material from the material transfer unit. In another aspect of the invention, two or more secondary processing steps can occur during and/or after the expulsion of material from the material transfer unit.

Adding an additional secondary processing step to facilitate uniform distribution of the applied material subsequent to it being deposited on the substrate provides a substrate with a more uniform thickness of applied material. A more uniform thickness, in turn, will provide desirable improvements in certain optical qualities; e.g., reduction in wave interference effects, reduction in distortion, reduction in average surface roughness, reduction in localized errors, and improved scratch resistance. The aim in the production of ophthalmic lenses, as it relates to surface finish, is to achieve average surface roughness (Ra) values of below 10 nanometers. As it relates to a form accuracy, the aim in the production of ophthalmic lenses is to ensure that any localized error (departure from the desired curve) is less than 0.5 microns over any 1 mm linear distance. Any departure from this could result in a lens anomaly (a localized power distortion) sometimes referred to as a power wave.

The process of discretely depositing material to an optical substrate can be done by any material transfer apparatus as is commonly known in the art. A material transfer unit can include, but is not limited to, a jetting device. The jetting device may be any type of jetting device capable of selectively applying a predetermined amount of material to a substrate at a particular position. The present invention is not limited to any particular type of jetting device. An example of an acceptable jetting device is a piezo-electric type jet similar to those used in ink-jet applications, wherein the volume of a chamber containing the material is decreased a predetermined amount (e.g., squeezed) by the piezo-electric mechanism. The decrease in volume causes a predetermined amount of material to be expelled out of the orifice, and subsequently deposited onto the substrate. Depending upon the material to be applied, it may also be possible to use a bubble-type jetting device, wherein the material is heated until a bubble is formed. The bubble subsequently bursts to expel the material onto the substrate. The characteristics of the jetting device may be varied to accommodate the characteristics of the material being applied. For example, the size of the jetting device's orifice may be increased or decreased to accommodate different viscosity materials, and different flow rates. As another example, the amount of force required to expel the predetermined amount of material from the chamber may be changed for different viscosity materials. The jetting device may include a single chamber and orifice, or a plurality of chambers, and a plurality or orifices; e.g., a multi-jet head. Examples of other suitable jetting devices are disclosed in U.S. Pat. No. 3,465,350 to Keur et. al.; U.S. Pat. No. 3,465,351 to Keur et. al.; and U.S. Pat. No. 6,656,256 to Moreland, which are all incorporated herein by reference in their entireties.

Since the jetting device is capable of selectively applying a predetermined amount of material to a substrate at a particular position, this application method minimizes the amount of waste material created during the application to the optical substrates, and the need to reprocess waste applied material. In another aspect of the invention, the application process includes selectively applying material to certain regions to create the desired refracting properties in one or more applications. This method also minimizes the amount of waste material created during the application of the optical substrates, and/or eliminates the need to reprocess waste material. In another aspect of the invention, in some applications, the size and number of jets, and/or the size of the substrate prevent the entire substrate from being covered by the material expelled from the jet(s), absent relative movement between the substrate and the jetting device. In these cases, the jetting device and the substrate are moved relative to one another during material application. Relative movement between the substrate and the jetting device allows material to be applied to the desired areas of the optical substrate. This aspect of the invention method also minimizes the amount of waste material created during the application of the optical substrates and the need to reprocess waste material.

The jetting device is disposed in close relative proximity to the substrate. The position of at least one of the jetting device and the substrate is known relative to the other. A variety of techniques can be used to locate the jetting device and the substrate relative to one another (e.g., ultrasonics, physical referencing, using manufacturing data). The present invention is not, therefore, limited to any particular technique. The relative positioning of the jetting device and the substrate contemplates that the substrate may be planar or non-planar. Hence, in some applications the relative positioning will account for positioning along at least x, y and z axes. Depending upon the application, the relative positioning may also account for the relative angular orientation between the jetting device and the substrate. Hence, the relative positioning may account for more than three degrees of freedom.

Once the jetting device and the substrate are relatively positioned, the jetting device is actuated to expel the material onto the optical substrate. Depending upon the application, the jetting device may be actuated once at a particular position or many positions; or, a plurality of times at a particular position or many positions as desired.

According to a first aspect of the present invention, materials are applied to an optical substrate for the purpose of creating an ophthalmic lens. The material is deposited on the substrate in a manner that results in the substrate having desired refracting properties. The substrate may have an initial geometry that lends itself to the lens being manufactured (e.g., a base prescription), or it may be neutral and therefore universal to most applications. The application process includes selectively applying material to certain regions to create the desired refracting properties in one or more applications. A desirable thickness, which is greater than that practically possible in one application, can be achieved by repeating the application process a plurality of times. Examples of materials that may be applied using the present invention include, but are not limited to, a thermosetting plastic such as diethyleneglycol bis-allylcarbonate copolymer (CR-39.RTM. from PPG Industries) or a thermoplastic plastic such as polycarbonate (PC). This aspect of the present method is not limited to the creation of ophthalmic lenses and can be used to apply any material to any optical substrate to create optical devices such as facemasks, shields, goggles, visors, displays or window devices, and other materials known to those skilled in the art. It will also be appreciated that a lens may be created by applying one or more coatings of material having a particular refractive index in a manner that gives the substrate desired refractive properties.

According to another aspect, the present invention is used to apply one or more materials to one or both faces of an optical substrate such as a finished or semi- finished ophthalmic lens. Typically, but not necessarily, the material is applied to the substrate (e.g., a lens) in a manner that creates a coating of uniform thickness. In typical applications, the size and number of jets, and/or the size of the substrate prevent the entire substrate from being covered by material expelled from the jet(s), absent relative movement between the substrate and the jetting device. In these cases, the jetting device and the substrate are moved relative to one another to perform the desired applications. The relative movement assists the material to be applied to all the desired areas of the substrate. Any relative movement between the jetting device and the substrate that assists the applicable surface area of the substrate to be covered can be used. For example, if the substrate is rotated on a spindle and the jetting device is moved radially inwardly (or outwardly) at a given feed rate, material can be applied to the substrate in a spiral pattern. As another example, if the substrate is rotated on a spindle and the jetting device is moved radially inwardly (or outwardly) in discrete steps, material can be applied to the substrate in a concentric circle pattern. As yet another example, if the substrate is held stationary and the jetting device is moved laterally across the substrate at increasingly different heights, material can be applied to the substrate in a raster type pattern.

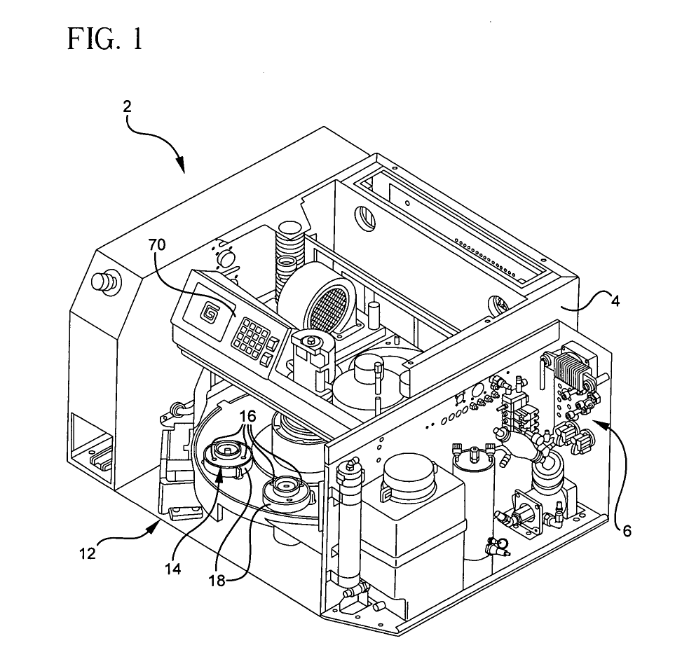

As shown in FIG. 1, an apparatus for applying materials to an optical substrate for the purpose of creating a lens, or for applying surface coatings to one or more surfaces of an optical substrate, is generally designated by the reference numeral 2 and includes a base 12, with a side panel 4, having a rotating disc 14 rotably mounted thereon. A pumping apparatus 6 is attached to the side panel 4. Rotating platforms 16 are attached to the rotating disc 14. Each rotating platform 16 contains a holder 18. A control panel 10 is mounted on the side panel 4. The control panel coordinates the motion of the rotating disc 14, and coordinates the motion of rotating platforms 16.

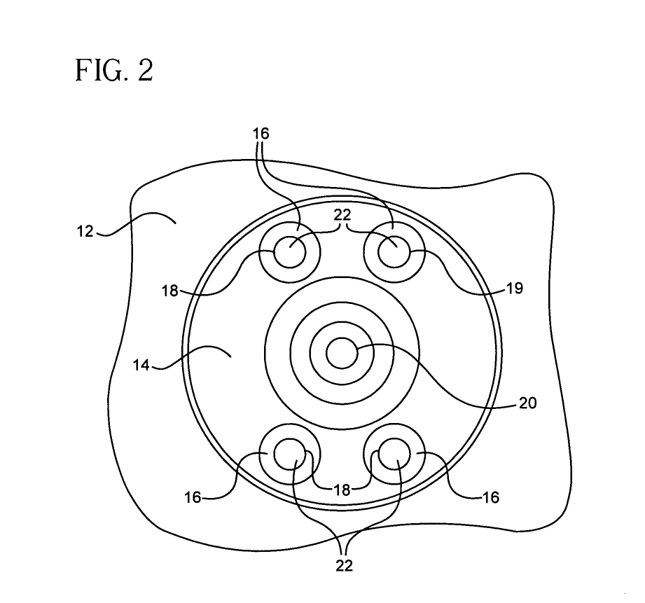

As shown in FIGS. 1 and 2, rotating disc 14 is rotably mounted to base 12 of apparatus 2 by center rod 20. Substrate 22 is positioned in each holder 18 located on each rotating platform 16.

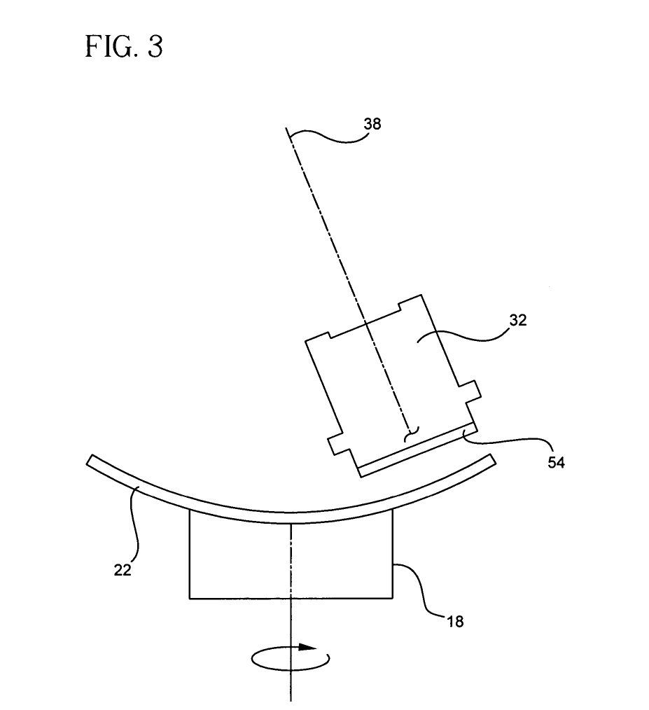

As shown in FIG. 3, a print-head (or nozzle array) generally designated by the reference numeral 32 includes a pivot point 38 and nozzle(s) 54. Print-head 32 can be any type of print-head or jetting device. Substrate 22 is positioned on holder 18. The print-head 32 or substrate 22 are then moved relative to one another while a predetermined amount of material is expelled from print-head 32 through nozzle(s) 54 onto substrate 22. Print-head 32 may expel material at a particular location or many locations on substrate 22; or, a plurality of times at a particular location or many locations on substrate 22.

As shown in FIG. 3, print-head 32 may have one nozzle 54, or print-head 32 may have many nozzles 54. The size and the location of nozzles 54 of print-head 32 can vary. Nozzles 54 are positioned over substrate 22 so that the material may be applied to selected portions of substrate 22. As a result, it is possible to apply materials to select portions of substrate 22, while not applying the materials to other portions of substrate 22. In an alternative embodiment, substrate 22 can be rotated so that material can be expelled from print-head 32 onto both sides of substrate 22 [not shown]. In another embodiment, substrate 22 may be held stationary on holder 18 and print-head 32 may be moved laterally across the substrate at increasingly different heights. While the present invention has been shown and described as including a single print-head 32 for depositing a single material, it is not limited in this regard as two or more print-head assemblies for applying various materials may be employed without departing from the broader aspects of the invention.

As shown in FIGS. 1-3, after the material has been expelled onto substrate 22, an additional step to facilitate uniform distribution of the material is performed by apparatus 2. More specifically, after the material has been applied to substrate 22, rotating platforms 16 containing substrate 22 may spin, providing centrifugal force to substrate 22, causing the material to be uniformly distributed to the selected areas on substrate 22. In an alternative embodiment, as the material is being applied by print-head 32 onto substrate 22, the rotating platforms 16 cause the substrate to rotate in response to commands issued from the control panel 10, FIG. 1. This rotation imparts centrifugal force to the applied material causing it to spread uniformly on the selected portions of the substrate 22. Alternatively, rotating platforms 16 may be utilized to provide a secondary processing step such as a substrate vibration step, a heat transfer step, a curing step, or the like, in order to desirably change the physical properties of the material once it is applied onto substrate 22.

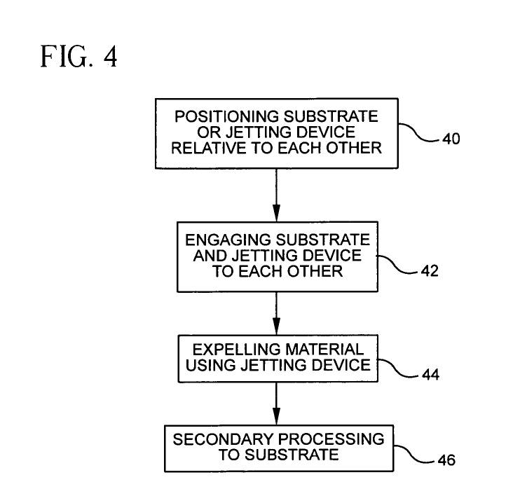

FIG. 4 sets forth the overall method for applying materials to a substrate. In the first step 40, either the substrate or the jetting device is positioned relative to the other. In the next step 42, the jetting device and the substrate are in communication with each other. In the next step 44, material is expelled from the jetting device onto the substrate. In the final step 46, a secondary processing step is performed by apparatus 2 in order to desirably change the properties of the material once it is applied to the substrate.

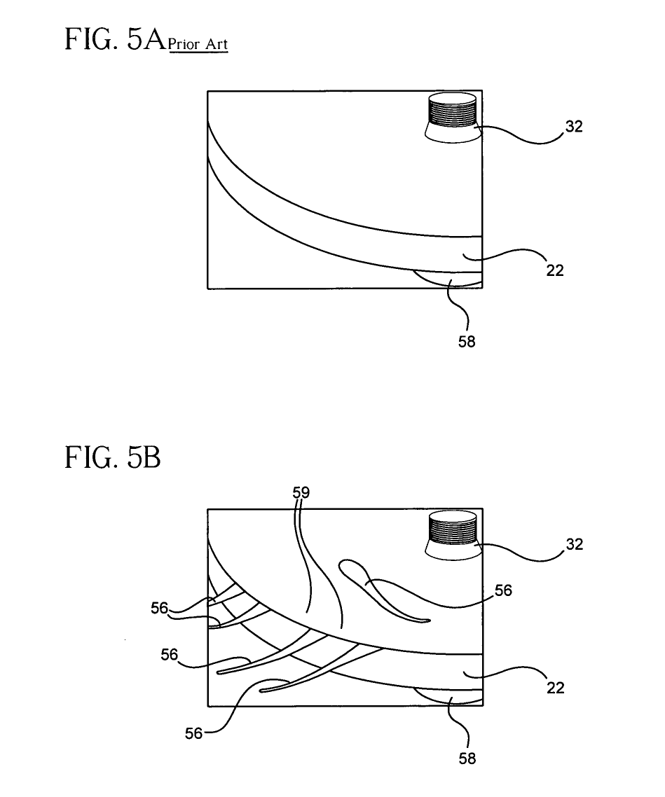

Adverting to FIGS. 5A and 5B, illustrated is an example of a spin coating process utilized in the present invention. Spin coating has been used for several decades and is typically used in the application of thin and uniform coatings to an object, such as substrate 56 illustrated in FIGS. 5A and 5B. The spin coating process can also be used to remove excess material 58.

The spin coating process works by applying an amount of material 56 generally through a print-head 32 onto substrate 22. In some embodiments an amount of between about 1 cc to 10 cc may be used to coat a lens. This amount may vary depending on the thickness of the coating desired. The substrate is then rotated by a rotational device 58 at a high speed in order to spread the material by centrifugal force. The rotational device 58 can be any device known to those skilled in the art. The rotation speed during dispensing of the applied material is typically between about 0-560 rpms depending on the application. Rotation speeds up to about 3000 rpms, can be used to spread and remove excess material on the substrate. This rotational speed can be varied depending on the application and thickness desired. Typical spin speeds from about 1560-1600 rpm can be used for a time of about 10 seconds to several minutes. The combination of spin speed and time typically defines the final thickness of the applied material.

The speed of the substrate affects the degree of radial (centrifugal) force applied to the material. Rotation can be continued for some time with applied material being spun off the edges off the substrate as illustrated in FIG. 5B until the desired film thickness is achieved. If the material is volatile, simultaneous evaporation of the material is achieved during the spinning process. Final film thickness and other optical properties depend on the properties of the material, such as, but not limited to viscosity, drying rate, percent solids, surface tension, and the parameters for the spin process. Such parameters for the spin process include final rotational speed, acceleration, and fume exhaust that all contribute to how the properties of the coated substrate are defined.

It may be appreciated that when material is discretely deposited from print-head 32 to an optical substrate, the material may be applied in a nearly level condition. The spin coating process is hen used to level out any imperfections in the surface of the nearly level surface of the applied material. Dispensed material of about more than 10 cc can be used to form the newly formed substrate. Holder 18 as previously described can hold the material as it is being dispensed through print-head 32, and during subsequent curing. If the material has poor wetting abilities, it is advantageous to spin holder 18 while dispensing the material to spread the material and reduce waste and voids.

Advantageously, the material transfer unit may also be adapted to discretely deposit a predetermined amount of temporary marking material (59) as illustrated in FIG. 5B to a particular location or locations on the optical substrate. As a result, subsequent processing steps performed on the optical substrate may be based upon the location of the temporary marking materials applied to the optical substrate.

For both the coating and manufacturing embodiments described above, a separate drying or curing step may be used after the high speed spin to further set the material without substantially thinning the material. One advantage to using a separate drying or curing step is when thick amounts of material are used such as, for example when a new lens is formed. In addition if a thick coating is desired the separate drying or curing step can increase physical stability of the material. Typically, a moderate spin speed of about 25% of the high speed spin will aid in drying the film without significantly changing the thickness of the material. Other methods of drying know to those skilled in the art may also be used such as, but not limited to, UV curing, radiant heat, microwaves, convection heating and the like.

Although this invention has been shown and described with respect to the detailed embodiments thereof, it will be understood by those skilled in the art that various changes in form and detail thereof may be made without departing from the spirit and the scope of the invention. Accordingly, it is to be understood that the present invention has been described by way of example, and not by limitation.

1. An apparatus for applying material to an optical substrate, comprising:
a holder for retaining the optical substrate;
a material transfer unit for applying material to the optical substrate;
a controller for positioning the optical substrate or the material transport unit relative to each other and providing for discrete deposition of material to one or more areas of the optical substrate.

2. The apparatus in claim 1, wherein the holder is rotatable.

3. The apparatus in claim 1, further including a rotating platform for removing and drying the applied material.

4. The apparatus of claim 1, wherein the material transfer unit is a jetting device that can selectively apply a predetermined amount of material to the optical substrate in a particular position.

5. The apparatus of claim 4, wherein the jetting device further includes a piezo- electric mechanism for dispensing the material.

6. The apparatus of claim 4, wherein the jetting device further includes a heater to heat the material for allowing a bubble of material to be formed and burst in a predetermined volume to expel material onto the optical substrate.

7. The apparatus of claim 4, wherein the jetting device further includes a single print-head having one or more nozzles.

8. The apparatus of claim 4, wherein the jetting device further includes a plurality of print-heads having one or more nozzles.

9. The apparatus of claim 1, further including at least one sensor for detecting the position and surface features of the substrate relative to the material transfer unit and to facilitate properly aligning application of material to the optical substrate.

10. The apparatus of claim 1, wherein the material transfer unit further includes programming to discretely deposit a predetermined amount of temporary marking material on the substrate.

11. The apparatus of claim 1, further comprising apparatus for removal of at least some of said material after said material has been discretely deposited on the optical substrate.

12. A method of creating or coating an optical substrate, comprising;
positioning either an optical substrate or a material transfer unit relative to the other;
placing the material transfer unit and the optical substrate in communication with each other; and
discretely depositing material from the material transfer unit onto the optical substrate in a selective position.

13. The method of claim 12, wherein the material transfer unit is a jetting device.

14. The method of claim 12, wherein at least one secondary processing step is performed in order to desirably change the properties of the material applied to the optical substrate.

15. The method of claim 14, wherein the secondary processing step is a substrate vibration step.

16. The method of claim 14, wherein the secondary processing step is a substrate spinning step.

17. The method of claim 14, wherein the secondary processing step is a heat transfer step.

18. The method of claim 14, wherein the secondary processing step is a curing step.

19. The method of claim 14, wherein the secondary processing step is a material removal step.

20. The method of claim 12, further including the step of depositing a predetermined amount of temporary marking material on the substrate.

21. The method of claim 12, depositing material on the optical substrate to obtain predetermined refractive properties.

22. An apparatus for applying material to an optical substrate, comprising:
a holder for retaining the optical substrate;
a material transfer unit for applying material to the optical substrate;
a controller for positioning the optical substrate or the material transport unit relative to each other for providing for discrete deposition of material to one or more areas of the optical substrate; and
means for changing the properties of the material applied to the optical substrate.

23. The apparatus of claim 22, wherein the means for changing includes a vibration mechanism for vibration of the substrate.

24. The apparatus of claim 22, wherein the means for changing includes a spinning mechanism for spinning the substrate.

25. The apparatus of claim 22 wherein the means for changing includes a heat transfer mechanism for transferring heat from the substrate.

26. The apparatus of claim 22, wherein the means for changing includes a curing mechanism for curing the substrate.

27. The apparatus of claim 22, wherein the means for changing includes a removal mechanism for removing material from the substrate.

28. The apparatus of claim 22, wherein the material transfer unit further includes programming to discretely deposit a predetermined amount of temporary marking material on the substrate.
